(19) United States
(12) Patent Application Publication
(10) Pub. No.: US 2019/0233720 A1
(43) Pub. Date: Aug. 1, 2019

(54) METHOD FOR COATING PROPPANTS

(71) Applicant: Wacker Chemie AG, Munich (DE)

(72) Inventors: Sebastian KNOER, Emmerting (DE); Daniel CALIMENTE, Saline, MI (US); Arndt SCHLOSSER, Stammham (DE)

(73) Assignee: Wacker Chemie AG, Munich (DE)

(21) Appl. No.: 16/317,701

(22) PCT Filed: Jul. 13, 2016
(86) PCT No.: PCT/EP2016/066681

§ 371 Date: Jan. 14, 2019

(51) Int. Cl. C09K 8/80; C03C 17/30; C03C 17/32; C03C 11/00; C03C 12/00

(52) U.S. Cl. CPC C09K 8/805; C03C 17/30; C09K 8/62; C03C 11/002; C03C 12/00; C03C 17/32

(57) ABSTRACT

Coated proppants which exhibit superior proppant coatings and less fines generation are prepared by coating proppant particles with a reactive hybrid resin prepared by reaction of a phenol-formaldehyde resin and a co-reactive organopolysiloxane having at least three repeating siloxy groups, and is in free flowing form.

### CROSS REFERENCE TO RELATED APPLICATIONS

This application is the U.S. National Phase of PCT Appln. No. PCT/EP2016/066681 filed Jul. 13, 2016, the disclosure of which is incorporated in its entirety by reference herein.

### BACKGROUND OF THE INVENTION

### 1. Field of the Invention

The present invention relates to a process for producing coated proppants that are used in hydraulic fracturing (=fracking).

### 2. Description of the Related Art

The fracking method is used in mineral oil and natural gas production and is a method of generating, widening and stabilizing cracks in the rock of a deposit deep underground, with the aim of increasing the permeability of the deposit box. As a result, gases or liquids present therein can flow in an easier and more stable manner to the well and be produced.

The cracks generated have to be kept open with proppants. The coated or uncoated proppants currently available are brittle and do not have the necessary compressive strength for production at high depths. The fracturing of the proppants under the high pressure releases fine particles that block the cracks and reduce the oil or gas production rate.

The coated proppants available according to prior art have improved stability compared to uncoated proppants. However, the effect of the coating, for example with organic resins, is limited by the fact that the available coatings themselves are very brittle and likewise have a tendency to fracture or flake off.

WO2008088449 A2 discloses a means of reducing the brittleness of the coatings of such particles, wherein thermally curing reactive resins, for example epoxy resins, are admixed with block copolymers and adhesion promoters in order thus to achieve an improvement in the impact resistance of the coating. In addition to the use of two additives, it is a further disadvantage that the toughness improver is a costly block copolymer which is difficult to prepare.

US2012088699A proposes coating particles with at least two oleophilic and hydrophobic resins, for example epoxy resins and silicone resins. The particles thus coated improve the oil yield and reduce the amount of water produced. The use of silicone resins makes these particles costly.

U.S. Pat. No. 8,852,682B2 discloses particles for use as proppant materials which have multiple partial coats interleaved together. A filler is explicitly metered in during the individual process steps. A disadvantage is the complex process. Various resins are used for coating, for example phenolic resins containing fumed silicas as reinforcing fillers.

U.S. Pat. No. 5,422,183A discloses particles for use as proppant materials in fracking methods which likewise have a two-layer coating composed of resins. Phenolic resins, for example, are used for coating, wherein fumed silicas are likewise used as a filler. This filler is introduced into the interphase of the individual layers after the first coating step. A disadvantage in both documents is the very complex multistage process which is costly and additionally difficult to control.

US20140124200A discloses the use of hybrid materials produced by chemical bonding of organic resins and silicone resins for coating of proppant materials. Disadvantages here are the use of costly silicone resins and the difficulty of controlling product quality in the case of reaction of two branched polymers.

In addition, processes that lead to a reduction in the brittleness of coatings are common knowledge in the prior art. WO2010060861A1 describes, for example, a homogeneous reaction resin which shows an improvement in the chemical properties of fracture toughness and impact resistance as a cured thermoset. In this case, for example, at least one organopolysiloxane is homogeneously distributed in an unhardened epoxy resin with the aid of a silicone organocopolymer which serves as dispersant.

It was therefore an object of the present invention to provide an inexpensive process for coating proppants and the coated proppants themselves. These proppants, after coating and curing, should have the necessary hardness and simultaneously show elastic properties such as good impact resistance, in order that there is no fracturing or flaking-off of the coating.

### SUMMARY OF THE INVENTION

The foregoing objects are surprisingly achieved by the process of the invention for producing coated proppants, in which coating is accomplished by applying to the proppant and then curing

i) a reactive hybrid resin (Z) or a mixture of at least two reactive hybrid resins (Z),

ii) together with or without at least one reactive resin (A), characterized in that the reactive hybrid resin (Z) is prepared by the following reaction:
(A) 80%-99.5% by weight of at least one reactive resin, and
(B) 0.5%-20% by weight of at least one linear or cyclic organopolysiloxane, with the proviso that
   (B) has at least 3 successive Si—O units
   (B) has at least one R¹ radical suitable for reacting with (A) to form a covalent bond and
   (B) is in free-flowing form at 20° C., or can be melted by heating within a temperature range up to 250° C. and hence can be converted to a free-flowing form.

### DETAILED DESCRIPTION OF THE PREFERRED EMBODIMENT

The reactive hybrid resins (Z) must form a firm, non-tacky coating at ambient temperatures. This is necessary in order that the coated particles remain free-flowing, such that they do not agglomerate under normal storage conditions. The coating can essentially be cured such that little or no crosslinking takes place under conditions within the borehole. The coating may also be only partly cured or provided with other reactive groups, such that covalent crosslinking takes place under the conditions in the borehole. The reactive hybrid resins (Z) can either be fully cured during the coating of the proppant particles or only partly cured. Proppants having an only partly hardened coating do not cure until they have been introduced into deeper strata during fracking.

Component (A)

Suitable reactive resins (A) in accordance with the invention are all polymeric or oligomeric organic compounds provided with a sufficient number of reactive groups suitable for a hardening reaction. All reactive resins known in the prior art that can be processed to thermosets are suitable, irrespective of the respective crosslinking mechanism that proceeds in the hardening of the respective reactive resin. In principle, they can be divided into three groups according to the nature of the crosslinking mechanism by addition, condensation or free-radical polymerization.

From the first group of the polyaddition-crosslinked reactive resins (A), preference is given to selecting one or more epoxy resins, urethane resins and/or air-drying alkyd resins are starting material. Epoxy resins and urethane resins are generally crosslinked by addition of stoichiometric amounts of a hardener containing hydroxyl, amino, carboxyl or carboxylic anhydride groups, the hardening reaction being effected by addition of the oxirane or isocyanate groups in the resin onto the corresponding groups in the hardener. In the case of epoxy resins, catalytic hardening is also possible by polyaddition of the oxirane groups themselves. Air-drying alkyd resins crosslink through autoxidation with atmospheric oxygen. Addition-hardening silicone resins are also known, preferably those with the proviso that no further free silanes are present.

Examples of the second group of reactive resins (A) that are crosslinked by polycondensation are preferably condensation products of aldehydes, e.g. formaldehyde, with aliphatic or aromatic compounds containing amino groups, for example urea or melamine, or with aromatic compounds such as phenol, resorcinol, cresol etc., and also furan resins, saturated polyester resins and condensation-hardening silicone resins. The hardening usually takes place here via increasing temperature with elimination of water, low molecular weight alcohols or other low molecular weight compounds.

From the third group of the reactive resins crosslinked by free-radical polymerization, preferred starting resins for the reactive resins modified in accordance with the invention are one or more homo- or copolymers of acrylic acid and/or methacrylic acid or esters thereof, and also unsaturated polyester resins, vinyl ester resins and/or maleimide resins. These resins have polymerizable double bonds, the polymerization or copolymerization of which brings about three-dimensional crosslinking. The starters used are compounds capable of forming free radicals, for example peroxides, peroxo compounds or compounds containing azo groups.

It is also possible to initiate the crosslinking reaction by means of high-energy radiation, such as UV or electron beams.

Not just the aforementioned reactive resins (A), but also all others suitable for production of thermosets, can be modified in the manner proposed in accordance with the invention and, after crosslinking and hardening, result in thermosets having considerably improved fracture and impact resistance, with retention of other essential properties characteristic of thermosets, such as strength, heat distortion resistance and chemical resistance, in an essentially unchanged manner.

The preferred reactive resins (A) are the polycondensation-crosslinked phenol-formaldehyde resins. These reactive resins (A) include heat-curing phenol resins of the resol type and phenol-novolak resins, which can be rendered thermally reactive by addition of catalyst and formaldehyde.

Particularly preferred reactive resins (A) are phenol-novolak resins. These are obtainable, for example, from Plastics Engineering Company, Sheboygan, USA, under the Resin 14772 name. If such a reactive resin is used, it is necessary to add a crosslinking agent (C) to the mixture in order to bring about the subsequent curing of the reactive resin. Hexamethylene-tetramine is the preferred material as (C) for this function, since it serves both as catalyst and as a formaldehyde source.

(A) is used for reaction with (B) in amounts of 80-99.5% by weight, preferably in amounts of 88-99% by weight and more preferably of 94-98% by weight.

The preferred reactive resins (A) are in free-flowing form at 20° C., or can be melted by heating within a temperature range up to 250° C. and hence can be converted to a free-flowing form.

Component (B)

The linear or cyclic organopolysiloxane (B) has at least 3, preferably at least 5, and more preferably at least 10, successive Si—O— units.

Linear or cyclic (B) may have a minor degree of branching or a minor degree of bridging by an organic radical. The average number of bridging or branching sites per molecule is preferably 4, more preferably 2, yet more preferably 1, and most preferably <1.

(B) is preferably a linear polyorganosiloxane.

The average number of silicon atoms per molecule of (B) is preferably less than 1000, more preferably less than 200.

(B) is used for reaction with (A) in amounts of 0.5-20% by weight, preferably 1-12% by weight and more preferably of 2-6% by weight.

It is a further important property of (B) that it is in free-flowing form at 20° C., or is meltable by heating within a temperature range up to 250° C. and can thus be converted to a free-flowing form.

Definition of “free-flowing form” for (B):

100 g of (B) are distributed over a 10 cm² area of a sieve having mesh size 1 mm. Within 72 h, a significant proportion of the material, i.e. at least 90%, flows through the sieve. The material of (B) above the sieve meshes which can be stripped off with a spatula is considered to be residue which has not run through the sieve. This residue is weighed in order to determine whether (B) is free-flowing.

Depending on the reactive resin (A), the organopolysiloxane (B) is selected such that it has reactive R² radicals that are suitable in accordance with the nature of the crosslinking mechanism. The person skilled in the art has long known of suitable R² radicals for reactive resins that crosslink via polyaddition or polycondensation or free-radical polymerization.

There are suitable examples hereinafter for reactive R² radicals in the organopolysiloxane (B) that can be used in the case of use of the reactive resins (A) that crosslink via polycondensation.

If reactive resins (A) that crosslink via polycondensation, especially the preferred phenolic resins, are used, suitable species for (B) are those having a reactive R² radical that have electrophilic or nucleophilic groups. Preference is given to electrophilic groups. It may be the case that a catalyst is required to accelerate the reaction. This is known to the person skilled in the art (in accordance with the customary methods of organic chemistry).

Examples of suitable nucleophilic groups in R¹ are —SH, —OH and —(NH)—, preferably —(NH)— and —OH, more preferably —OH. Examples of suitable electrophilic groups in R¹ are known to those skilled in the art. These are preferably epoxy, anhydride, acid halide, carbonyl, carboxyl, alkoxy, alkoxy-Si, halogen or isocyanate groups. Preference is given to epoxy, anhydride, carbonyl, alkoxy, carboxyl, particular preference to epoxy, alkoxy and anhydride.

Preferred reactive R¹ radicals are anhydrides, such as the maleic anhydride group or the succinic anhydride group, especially bonded via a propyl radical or an undecyl radical.

Further preferred reactive R¹ radicals are epoxy radicals of the following formulae (VI) and (VII)

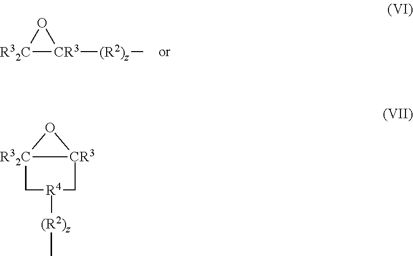

where

R² is a divalent hydrocarbyl radical which has 1 to 10 carbon atoms per radical and may be interrupted by an ether oxygen atom,

R³ is a hydrogen atom or a monovalent hydrocarbyl radical which has 1 to 10 carbon atoms per radical and may be interrupted by an ether oxygen atom,

R⁴ is a trivalent hydrocarbyl radical having 3 to 12 carbon atoms per radical and

z is 0 or 1.

Examples of such epoxy radicals R² are
glycidoxypropyl,
3,4-epoxycyclohexylethyl,
2-(3,4-epoxy-4-methylcyclohexyl)-2-methylethyl,
3,4-epoxybutyl,
5,6-epoxyhexyl,
7,8-epoxydecyl,
11,12-epoxydodecyl and
13,14-epoxytetradecyl radical.

Preferred epoxy radicals are the glycidoxypropyl radical and the 3,4-epoxycyclohexylethyl radical.

Further preferred reactive R¹ radicals are amino radicals of the general formula (VIII)

—R⁶—[NR⁷—R⁸—]ₙNR⁷₂ (VIII)

where R⁶ is a divalent linear or branched hydrocarbyl radical having 3 to 18 carbon atoms, preferably an alkylene radical having 3 to 10 carbon atoms,

R⁷ is a hydrogen atom, an alkyl radical having 1 to 8 carbon atoms or an acyl radical, such as acetyl radical, preferably a hydrogen atom,

R⁸ is a divalent hydrocarbyl radical having 1 to 6 carbon atoms, preferably an alkylene radical having 1 to 6 carbon atoms,

n is 0, 1, 2, 3 or 4, preferably 0 or 1.

Further preferred reactive R¹ radicals are polyether radicals of the general formula (IX)

—CH₂CH₂(CH₂)ᵤO(C₂H₄O)ᵥ(C₃H₆O)_{w}(C₄H₈O)ₓ—H (IX)

where

u 0 or an integer from 1 to 16, preferably 1 to 4,

v 0 or an integer from 1 to 35, preferably 1 to 25, and

w 0 or an integer from 1 to 35, preferably 1 to 25,

x 0 or an integer from 1 to 35, preferably 1 to 25,

with the proviso that the sum total of v+w+x is 1 to 70,

preferably 1 to 50.

Further preferred substituted R¹ radicals are organic polymer radicals with formation of a polysiloxane-containing copolymer. These copolymers may be block copolymers or graft copolymers. Examples of suitable organic moieties are, but are not limited to, polycaprolactone, polyesters, polyvinyl acetates, polystyrenes, polymethylmethacrylates. The organic moiety is preferably a (co)polymer of vinyl acetate, methyl methacrylate or aliphatic polyester. It is more preferably polycaprolactone.

The block copolymers contain a siloxane unit having a molecular weight of 1000-10 000 g/mol, preferably 1500-5000 g/mol, more preferably 2000-4000 g/mol.

Particularly preferred radicals are alkoxy radicals, especially Si-bonded alkoxy radicals such as the methoxy radical and the ethoxy radical, hydroxyl radicals, especially the 3-hydroxypropyl radical, anhydride radicals such as the succinic anhydride radical, especially those bonded via a propyl radical or an undecyl radical, amino radicals, especially the 3-aminopropyl radical and the (2-aminoethyl)-3-aminopropyl radical, polyether radicals, epoxy radicals, especially the glycidoxypropyl radical and the 3,4-epoxycyclohexylethyl radical, and organic polymer radicals, especially a polycaprolactone radical.

Especially preferred R¹ radicals are organic hydroxyl radicals, especially the 3-hydroxypropyl radical, polyether radicals, epoxy radicals, especially the glycidoxypropyl radical and the 3,4-epoxycyclohexylethyl radical; where particular preference is given to epoxy radicals and polyether radicals and especial preference is given to epoxy radicals.

Catalyst

According to the reactive resin (A) used, a suitable catalyst is also used to accelerate the reaction of (A) with (B). Suitable catalysts for the reactive resins (A) that crosslink via polyaddition and polycondensation have long been known to those skilled in the art.

Solvent

The reaction of (A) with (B) can be effected with or without solvent. Suitable solvents are known to those skilled in the art and are selected depending on the reactive resin (A). In the case of phenolic resins, suitable solvents are, for example, ethyl acetate and acetone. Which solvents are suitable for which reactive resins is described, for example, in the following textbook: Polymer Handbook, Volume 2, 4th ed.; J. Brandrup, E. H. Immergut, E. A. Grulke; John Wiley & Sons, Inc., 1999 (ISBN 0-471-48172-6).

Suitable mixers are, for example, laboratory mixers, planetary mixers or dissolvers, rotor-stator systems, or else extruders, rolls, 3-roll mills, etc.

There follows a description of a process for producing the reactive hybrid resin (Z).

In one embodiment, this is effected by mixing (B) with (A) which is free-flowing at 20° C. or with (A) that has been rendered free-flowing by prior heating to up to 250° C., or with (A) that has been dissolved in a suitable solvent, and then reacting it with or without addition of a suitable catalyst. If a solvent has been used, this can be evaporated thereafter.

The person skilled in the art will be aware of various ways of coating proppants with resins from the prior art. These processes can be used analogously for the coating of proppants with the reactive hybrid resin (Z) of the invention.

In a preferred embodiment, both the reactive hybrid resin (Z) and the reactive resin (A), in free-flowing form
i.e. already free-flowing at 20° C. or
melted by heating to 250° C. and therefore free-flowing or
dissolved in a suitable solvent and therefore free-flowing is applied to the proppant together with or without at least one hardener (C) and with or without at least one additive (D), and then cured.

In a particularly preferred embodiment, both the reactive hybrid resin (Z) and the reactive resin (A) are melted by heating to 250° C. and applied to the proppant, for example by spraying or mixing, together with or without at least one hardener (C) and with or without at least one additive (D), and then cured.

The statements above are applicable to the solvents.

In a particularly preferred embodiment, a suitable proppant, for example sand, is preheated to about 170-260° C. In a mixer, the reactive hybrid resin (Z) and the reactive resin (A), a suitable hardener (C) and optionally various additives (D) are then added.

The production of layers should be understood as follows: multiple layers are produced in multiple successive coating and hardening cycles. In other words, after the wetting of the surface of the proppants with the reactive hybrid resin (Z) of the invention and any reactive resin (A), this layer is at first partly or fully hardened. Subsequently, a new layer of the reactive hybrid resin (Z) of the invention and any reactive resin (A) is applied and again partly or fully hardened.

This contrasts with the application of the reactive hybrid resin (Z) of the invention and any reactive resin (A) in portions in multiple steps without any substantial intermediate hardening of the individual portions, and only at the end is there partial or complete hardening. Thus, this leads only to a single layer.

Proppants

Suitable proppants have long been known to the person skilled in the art from the prior art and can be used for the coating of the invention. Proppants are typically hard particles of high-strength, for example sand or gravel composed of rocks such as limestone, marble, dolomite, granite etc., but also glass beads, ceramic particles, ceramic spheres and the like, this list being illustrative and nonlimiting. Preferably, the proppant particles exhibit an essentially spherical, i.e. ball-shaped form, since these leave sufficient interspace in order that the crude oil or gas can flow past. Therefore, coarse-grain sand, glass beads and hollow glass spheres (called microballoons) are preferred as proppants. Particular preference is given to using sand as proppant.

Preferably, the proppant particles have an average size of 5000 to 50 μm, more preferably an average size of 1500 to 100 μm. In addition, they preferably have an aspect ratio of length to width of not more than 2:1.

Hardeners (C)

Suitable hardeners have long been known to the person skilled in the art from the prior art and are selected in accordance with the reactive resin used. A preferred hardener (C) for novolaks is urotropin. The hardener (C) and hence urotropin as well, is typically used in amounts between 8% and 20% by weight, based on the amount of reactive hybrid resin (Z) of the invention and any reactive resin (A) present. Preferably, urotropin is applied to the melt of the reactive resin as an aqueous solution. Methods of this kind are likewise known to the person skilled in the art and are described, for example, in U.S. Pat. No. 4,732,920.

Additive (D)

Suitable additives (D) have likewise long been known to the person skilled in the art from the prior art. Non-exclusive examples are antistats, separating agents, adhesion promoters, etc.

Suitable proppants, hardeners (C) and additives (D) are described, for example, in U.S. Pat. No. 4,732,920 and US2007/0036977 A1.

For optimal performance of the proppant coated in accordance with the invention, the type and specification of the proppant, type and specification of the reactive hybrid resin (Z), reactive resin (A), organopolysiloxane (B), hardener (C) and any additives (D), the type of mixing and coating process, the sequence of addition of the components and the mixing times have to be matched to one another according to the requirement of the specific application. Any change in the proppant, under some circumstances, requires adjustment of the coating process and/or the hardeners (C) and additives (D) used.

The present invention thus also further provides the coated proppants that have been coated in accordance with the invention and are obtainable by the process described above.

In the proppants of the invention, the surface of the proppant may have been wholly or partly coated. Preferably, on examination by scanning electron microscope, at least 20% of the visible surface of the proppant has been coated with the reactive hybrid resin (Z) of the invention and any reactive resin (A), more preferably at least 50%.

Preferably, on examination by scanning electron microscope, at least 5% of the proppant particles are fully coated on their visible side, more preferably at least 10%.

The major portion of the coating on the proppant of the invention is 0.1 to 100 μm thick, preferably 0.1 to 30 μm, more preferably 1 to 20 μm.

Preferably, the proppants of the invention have been coated with fewer than three layers of the reactive resin composition of the invention, more preferably with just one layer.

The reactive hybrid resin (Z) of the invention is preferably used in amounts of 0.1-20% by weight, based on the weight of the proppant, preferably of 0.5-10% by weight and most preferably 1-5% by weight.

The present invention further provides for the use of the proppants coated in accordance with the invention in fracking production methods for mineral oil and natural gas.

### Advantages of the Invention

Compared to the prior art, the reactive hybrid resins (Z) of the invention are considerably less costly to produce since comparatively inexpensive silicone oils are used as raw material rather than costly silicone resins.

The reactive hybrid resins (Z) of the invention have improved leveling properties in coating processes. As a result, surfaces are coated more uniformly. It is possible to obtain smoother and shinier surfaces on the coated proppants.

The reactive hybrid resins (Z) of the invention show advantages in the coating of proppants in that the level of reject material resulting from sticking of the coated proppant is noticeably reduced.

The hardened reactive hybrid resins (Z) of the invention have improved toughness, elasticity and formability at the same hardness. As a result, it is more resistant to stresses such as impacts, deformation or pressure and has a lower tendency to fracture.

The reactive hybrid resins (Z) of the invention, as a hardened coating the proppants, have improved fracture resistance, toughness and elasticity. The coating has a reduced tendency to fracture and flake off and protects the proppant more effectively and for a longer period of time against high pressures and impacts. Thus, the stability of the overall proppant is improved.

Conventional proppants according to prior art are very brittle and have a high tendency to fracture. Fracture of the proppant results in release of fines. Release of fines has an adverse effect on the rate at which the crude oil or natural gas flows through in that the interstices between the proppant grains are blocked. This quickly makes the oil or gas source unviable. New wells or refracking become necessary.

By contrast, the proppants coated in accordance with the invention are more resistant to stresses such as impacts, the formation of pressure and thus have a lower tendency to fracture.

A further advantage of the coating of the invention lies in its formability, such that it frequently does not itself fracture on fracturing of the brittle proppant grains and thus encases or retains the resultant fines like a plastic shell and hence overall reduces the release thereof.

These advantageous properties of the proppants coated in accordance with the invention allow oil or gas flow to be maintained for longer. This gives rise to the crucial economic advantages and in environmental protection.

### EXAMPLES

The examples which follow elucidate the invention without having any limiting effect. In the examples described hereinafter, all figures given for parts and percentages, unless stated otherwise, are based on weight. Unless stated otherwise, the examples which follow are conducted at a pressure of the surrounding atmosphere, i.e. at about 1000 hPa, and at room temperature, i.e. at 25° C., or at a temperature which is established on combination of the reactants at room temperature without additional heating or cooling. All viscosity figures hereinafter relate to a temperature of 25° C.

Abbreviations Used

The meaning of the abbreviations used further up also applies to the examples:

ex=example

PTFE=polytetrafluoroethylene

rpm=revolutions per minute

### Example 1

A glass flask was purged with nitrogen, charged with 475 g of novolak “Resin 14772” (Plastics Engineering Company, Sheboygan, USA) and purged with nitrogen once again. The material was melted at 130° C. Then a stirrer was switched on at 420 rpm. 25 g of silicone oil 1 (an α,ω-functional silicone oil having about 10-18 Si—O units and terminal hydroxypropyl groups; dynamic viscosity at 25° C., Brookfield, 10-60 mPa·s) and 5 g of oxalic acid were added, and then the mixture was stirred under reflux at 420 rpm initially at 130° C. for 1 h. Then the mixture was heated to 180° C. within 2 h, and condensate that occurred was removed. This was followed by distillation at 180° C. for a further 30 min. The liquid material is poured hot onto a PTFE film. After cooling, the solid material is mechanically comminuted and hence a granular material is produced.

### Example 2

By the method of example 1, 25 g of silicone oil 2 (an α,ω-functional silicone oil having about 40-60 Si—O units and terminal 4-hydroxy-3-methoxyphenylpropyl groups; kinematic viscosity to DIN 51562 at 25° C.: 80-130 mPa·s) rather than silicone oil 1 were incorporated and a granular material was produced.

### Example 3

By the process of example 1, 25 g of SIPELL® RE 63 F (a polydimethylsiloxane with glycidoxypropylmethylsiloxy units and about 100-160 Si—O units; dynamic viscosity at 25° C. about 300 mPa·s; to be sourced from Wacker Chemie AG, Munich) rather than silicone oil 1 were incorporated and a granular material was produced.

### Example 4

By the process of example 1, 25 g of silicone oil 3 (a trimethylsiloxy end-capped polydimethylsiloxane having about 75-85 Si—O units, consisting of dimethylsiloxy units and an average of 2.5 glycidoxypropylmethylsiloxy units and an average of 2.5 (hydroxy(polyethyleneoxy) (polypropyleneoxy)propyl)-methylsiloxy units per molecule; dynamic viscosity at 23° C., Brookfield, 2300-2500 mPa·s) rather than silicone oil 1 were incorporated and a granular material was produced.

### Example 5

By the process of example 1, 25 g of silicone oil 4 (an α,ω-functional silicone oil having about 15-20 Si—O units and terminal hydroxy(polyethyleneoxy) groups with about 10 repeated ethylene oxide units; dynamic viscosity at 25° C., Brookfield, 150-300 mPa·s) rather than silicone oil 1 were incorporated and a granular material was produced.

### Example 6

By the method of example 1, 25 g of WACKER® FINISH WT 1650 (a linear aminoethyl-aminopropyl-functional polydimethylsiloxane; dynamic viscosity at 25° C., about 1000 mPa·s; amine value about 0.6 ml of 1 N HCl/g of substance; available from Wacker Chemie AG, Munich) rather than silicone oil 1 were incorporated and a granular material was produced, except that no oxalic acid was added.

### Comparative Example 1 (V1)

By the process of example 1, 25 g of WACKER® AK 100 SILICONOEL, a non-functional, trimethylsiloxy end-capped polydimethylsiloxane, rather than silicone oil 1 are incorporated.

WACKER® AK 100 SILICONOEL does not have any functional groups suitable for entering into a reaction with the reactive resin. What is formed is a noninventive physical mixture of the components. The oil does not form a stable mixture with the reactive resin and is unsuitable for the application.

It is a characteristic feature of a stable mixture that no separation through formation of a second phase is observed within two weeks in the course of storage of the mixture in liquid form. In the case of the phenolic resin, the storage is at 140° C. under nitrogen.

### Comparative Example 2 (V2)

By the method of example 1, 25 g of silicone oil 1 (an α,ω-functional silicone oil having about 10-18 Si—O units and terminal hydroxypropyl groups; dynamic viscosity at 25° C., Brookfield, 10-60 mPa·s) were incorporated. By contrast with example 1, no oxalic acid was added, and the mixture was stirred at 140° C. for a total of only 10 minutes before the hot material was poured onto PTFE film and comminuted.

Silicone oil 1 has functional groups that would be suitable for entering into a chemical reaction with the reactive resin. The short mixing time and the absence of the oxalic acid as catalyst prevents a chemical reaction. What is formed is a purely physical, noninventive mixture of the components that differs in that respect from the inventive hybrid resin according to example 1. The mixture according to comparative example V2 is unstable, and is unsuitable for the application.

### Comparative Example 3 (V3)

By the method of example 1, 25 g of SIPELL® RE 63 F (a polydimethylsiloxane with glycidoxypropyl-methylsiloxy units and about 100-160 Si—O units; dynamic viscosity at 25° C., about 300 mPa·s; available from Wacker Chemie AG, Munich) were incorporated. By contrast with example 1, no oxalic acid was added, and the mixture was stirred at 140° C. for a total of only 10 minutes before the hot material was poured onto PTFE film and comminuted.

SIPELL® RE 63 F has functional groups that would be suitable for entering into a chemical reaction with the reactive resin. The short mixing time and the absence of the oxalic acid as catalyst prevents a chemical reaction. What is formed is a purely physical, noninventive mixture of the components that differs in that respect from the inventive hybrid resin according to example 1. Although it is found that the mixture is stable in this case, the compressive strength of the coated proppant is significantly worse.

### Comparative Example 4 (V4)

Comparative example V4 is unmodified novolak “Resin 14772” (Plastics Engineering Company, Sheboygan, USA).

### Comparative Example 5 (V5)

By the method of example 6, 25 g of WACKER® FINISH WT 1650 (a linear aminoethyl-aminopropyl-functional polydimethylsiloxane; dynamic viscosity at 25° C., about 1000 mPa·s; amine value about 0.6 ml of 1 N HCl/g of substance; available from Wacker Chemie AG, Munich) were incorporated. By contrast with example 6, the mixture was stirred at 140° C. for only 10 minutes before the hot material was poured onto PTFE film and comminuted.

WACKER® FINISH WT 1650 has functional groups that would be suitable for entering into a chemical reaction with the reactive resin. The short mixing time by comparison with example 6 prevents a chemical reaction. What is formed is a purely physical, noninventive mixture of the components that differs in that respect from the inventive hybrid resin according to example 6. By contrast with the hybrid resin according to example 6, the physical mixture according to comparative example V5 separates after storage at 140° C. for 2 weeks and is thus unsuitable for the application.

### Example 7

Preparation of reactive hybrid resin solutions for production of test specimens and coating of Q-PANEL test sheets: 10 parts in each case of the inventive modified phenol resins from examples 1-6 or 10 parts of the noninventive modified phenol resin from comparative example V2 and V5 or 10 parts of the pure modified phenol Resin 14772 (Plastics Engineering Company, Sheboygan, USA) were dissolved in each case together with 1 part urotropin and 10.0 parts ethyl acetate (from Bernd Kraft, >=99%) by agitation overnight.

Table 1 shows the comparative data of the modified phenol-novolak resins.

TABLE 1

| | | Amount | | Storage |
|---|---|---|---|---|
| | | of (B) | Reactive | stability |
| | | [% by | end group | [2 weeks at |
| Ex. | Organopolysiloxane (B) | wt.] | R¹ of (B) | 140° C.] |
| 1 | Silicone oil 1 | 5 | hydroxyl | stable |
| 2 | Silicone oil 2 | 5 | hydroxyl | stable |
| 3 | SIPELL ® RE 63 F | 5 | epoxy | stable |
| 4 | Silicone oil 3 | 5 | epoxy, | stable |
| | | | hydroxyl | |
| 5 | Silicone oil 4 | 5 | hydroxyl | stable |
| 6 | WACKER ® FINISH WT 1650 | 5 | amino | stable |
| V1 | WACKER ® AK 100 | 5 | n/a | unstable |
| | SILICONOEL | | | |
| V2 | Silicone oil 1 | 5 | hydroxyl | unstable |
| V3 | SIPELL ® RE 63 F | 5 | epoxy | stable |
| V4 | No additive | n/a | n/a | n/a |
| V5 | WACKER ® FINISH WT 1650 | 5 | amino | unstable |

### Example 8

Production of phenolic resin-coated Q-PANEL test sheets: For the brittleness determination experiments, Q-PANEL test sheets were cleaned 3× with acetone on the brushed side and then flashed off in a fume hood for 1 h. Subsequently, 3 mL of the appropriate phenolic resin solution from example 6 were applied to each sheet and spread with a 100 μm coating bar, and then the solution was evaporated off in a fume hood overnight.

For hardening, the samples were placed into a cold drying cabinet, heated up to 160° C. while purging with nitrogen within 3 hours, kept at this temperature for 2 h and cooled down to 23° C. overnight.

The evaporation of the solvent gives rise to an about 50 μm-thick hardened resin layer on the sheet.

### Example 9

Testing of Durability:

By means of a ball impact tester, it is possible to examine the stability of the coating in isolated form. A conclusion is obtained with regard to the elasticity, impact resistance and fracture resistance of a coating.

For detection of the improved properties, i.e. toughness and impact resistance to impacts and pressure, according to Examples 7 and 8, a hardened layer of the inventive resins from examples 1, 2, 4 and 6 of thickness about 50 μm in each case was produced on a Q-PANEL test sheet, or, as comparative examples, a hardened layer of the unmodified Resin 14772 (Plastics Engineering Company, Sheboygan, USA) of thickness about 50 μm and of the noninventive resins from comparative examples V2 and V5. The coated sheets were tested in an Erichsen ball impact tester, model 304-ASTM, and the results were visually evaluated by a trained tester: for this purpose, a ball was allowed to fall from a defined, variable drop height onto the reverse side of the sheet (twin experiments in each case at different sites). The impact energy is found from the drop height multiplied by drop weight, reported in inches (in)×pounds (lbs). The impact energy is altered as follows: 5, 10, 15, 20, 25, 30, 35, 40 (in×lbs). The bulging impact sites were assessed visually for fissures and cracks and assessed relative to the reference.

Table 2 shows the assessment of the resin coating on Q-PANEL test sheets and the stability thereof by means of a ball impact tester.

TABLE 2

| Resin | Organopoly- | Description of | Impact | Result after ball |
|---|---|---|---|---|
| from ex. | siloxane (B) | coating | test | impact test |
| 1 | Silicone oil 1 | Smooth | ++ | No cracking up to |
| | | | | 40 inch × lbs |
| 2 | Silicone oil 2 | Smooth | + | Cracking at 25 |
| | | | | inch × lbs |
| 4 | Silicone oil 3 | Very smooth | ++ | No cracking up to |
| | | | | 40 inch × lbs |
| 6 | WACKER ® | Very smooth | ++ | No cracking up to |
| | FINISH WT | | | 40 inch × lbs |
| | 1650 | | | |
| V2 | Silicone oil 2 | Slightly rough, | 0 | Cracking from 5 |
| | | uneven | | inch × lbs |
| V4 | No additive | Slightly rough, | 0 | Cracking from 5 |
| | | uneven | | inch × lbs |
| V5 | WACKER ® | Slightly rough, | 0 | Cracking from 5 |
| | FINISH WT | uneven | | inch × lbs |
| | 1650 | | | |

The values for the impact test should be understood as follows:

“0” means a cracking profile similar to the reference. The reference shows distinct cracking even at the lowest energy, from 5 in×lbs. The extent of cracking is similar to the reference.

“+” means a better cracking profile than the reference, meaning that distinct cracks are only apparent at a higher energy in the range of 10-30 in×lbs, or the extent of cracking is distinctly reduced overall compared to the reference.

“++” means that no cracks are apparent up to an energy of 30 in×lbs.

It is found that the coatings of the invention lead to smoother surfaces. The cured coatings of the invention have significantly improved elasticity, impact resistance and fracture resistance compared to the unmodified comparative example V4 and to the noninventively modified comparative example V2. In the noninventively modified comparative example V5, in which the WACKER® FINISH WT 1650 organopolysiloxane, by contrast with the resin modified in accordance with the invention from example 6, is not chemically bonded to the reactive resin (A), no improvement in toughness was observed.

### Example 10

Production of Coated Proppants:

20-40 mesh fracking sand was coated by the melt process with 3.5% of the inventive resins from examples 3 to 5 or, as comparative examples, V4 and hardened with 10% by weight of urotropin, based on the amount of resin.

A major problem in the coating fracking sand is the sticking and permanent caking of grains of sand in the course of hardening of the reactive resin. The coarse fraction cannot be utilized, and has to be removed and disposed of in a costly and inconvenient manner. This gives rise to high costs, yield losses, and the environment is polluted. Completely surprisingly, we have found that the inventive reactive hybrid resins (Z) reduce the amount of waste formed by more than 50%. The result of this study can be seen in table 3.

TABLE 3

| Fracking sand | | Waste resulting from |
|---|---|---|
| coated with | Organopolysiloxane | caked sand particles in |
| resin from ex. | (B) | the coating process [%] |
| 3 | Sipell RE 63F | 3.4 |
| 4 | Silicone oil 3 | 2.6 |
| 5 | Silicone oil 4 | 3.5 |
| V4 | No additive | 8.6 |

Table 4 shows the evaluation of the coating quality of fracking sand with modified resin for example 3 and comparative example V2 by means of an electron microscope (SEM).

TABLE 4

| | Comparative example V2 | Ex. 3 |
|---|---|---|
| Good coating | 81% | 89% |
| Moderately good coating | 16% | 20% |
| Poor coating | 3% | 1 |

It is found that the reactive resin composition of the invention brings about more uniform and more effective coating of the surface of the proppant.

### Example 11

Study of Pressure Stability of Coated Proppants:

The pressure stability of the coated proppants according to example 10 was studied according to DIN EN ISO 13503-2 at pressure 14,000 PSI. The result is shown in table 5.

TABLE 5

| | | Relative amount of fines |
|---|---|---|
| Fracking sand | | formed in % at 14,000 PSI |
| coated with | Organopolysiloxane | based on comparative |
| resin from ex. | (B) | example V4 |
| 3 | Sipell RE 63F | 85 |
| 4 | Silicone oil 3 | 87 |
| 5 | Silicone oil 4 | 92 |
| V3 | Sipell RE 63F | 148 |
| V4 | No additive | 100 |

Table 5 shows the relative amount of fines formed after pressure treatment relative to fracking sand coated with noninventive unmodified Resin 14772 (Plastics Engineering Company, Sheboygan, USA) from comparative example V4. Completely surprisingly, it was found that, in the case of the proppants coated in accordance with the invention, 8-15% less fines is formed, by comparison with the proppant with unmodified coating. The proppant having noninventive coating with resin from comparative example V3, in which the components have not chemically reacted with one another, by contrast with the proppant coated in accordance with the invention with resin from example 3, actually shows a deterioration in compressive strength by comparison with the unmodified Resin 14772 (Plastics Engineering Company, Sheboygan, USA).

While the prior art teaches improvement of the mechanical properties, such as compressive strength and impact resistance of cured thermoset plastics, by homogeneous distribution of a silicone organocopolymer, what is found in the case of the proppants coated in accordance with the invention is entirely unexpectedly that specifically the chemical binding of an inventive organopolysiloxane (B) to the reactive resin (A) achieves an improvement in the properties, such as toughness and compressive strength.

1.-7. (canceled)

8. A process for producing coated proppants, comprising applying to the proppant and then curing, a composition comprising:
i) a reactive hybrid resin (Z) or a mixture of at least two reactive hybrid resins (Z),
ii) and optionally one or more reactive resins (A),
wherein the reactive hybrid resin (Z) is prepared by reacting:
(A) 80%-99.5% by weight of at least one reactive resin, and
(B) 0.5%-20% by weight of at least one linear or cyclic organopolysiloxane,
with the provisos that
the reactive resin (A) comprises a phenol-formaldehyde resin,
(B) has at least 3 successive Si—O units,
(B) has at least one R¹ radical suitable for reacting with (A) to form a covalent bond and this R¹ radical is an electrophilic R¹ epoxy, anhydride, carbonyl, alkoxy, or carboxyl radical, or is a nucleophilic R¹—(NH)— and OH— radical, and
(B) is in free-flowing form at 20° C., or can be melted by heating within a temperature range up to 250° C. and hence can be converted to a free-flowing form.

9. The process of claim 8, wherein both the reactive hybrid resin (Z) and the reactive resin (A) are applied to the proppant in free-flowing form,
at 20° C. or a free flowing form prepared by melting at a temperature up to 250° C.,
are dissolved in a suitable solvent and are therefore free-flowing, optionally with one or more hardeners (C) and optionally additives (D), and then cured.

10. A coated proppant, prepared by the process of claim 8.

11. A coated proppant, prepared by the process of claim 9.

12. In a fracking production method for mineral oil and natural gas, where a proppant is employed, the improvement comprising employing a proppant of claim 8.
